(19) United States
(12) Patent Application Publication
(10) Pub. No.: US 2003/0112109 A1
(43) Pub. Date: Jun. 19, 2003

(54) Low voltage bobbin of flyback transformers

(76) Inventors: Reiy Long Wang, Tao Yuan Hsien (TW); Chun Ming Liu, Tao Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/020,302

(22) Filed: Dec. 18, 2001

(51) Int. Cl. H01F 27/02

(52) U.S. Cl. 336/92

(57) ABSTRACT

A low voltage bobbin of a flyback transformer having a bobbin core, a base portion and an isolating member. The isolating member encompassing the bobbin core in a co-axial manner, a plurality of windings of secondary wires being wrapped around the bobbin core and a plurality of windings of primary wires being wrapped around the isolating member, the isolating member having at least a positioning portion correspondingly connected to the positioning portion of the bobbin core of the bobbin core.

### BACKGROUND OF THE INVENTION

1. Field of the Invention

The present invention relates to the field of flyback transformers, and more particularly, to a low voltage bobbin of a flyback transformer having an improved structure that can prevent short-circuiting and permit efficient assembling and steady operations.

2. Description of the Prior Art

Please refer to FIG. 1 and FIG. 2. FIG. 1 is an exploded diagram of a prior art low voltage bobbin of a flyback transformer (FBT). FIG. 2 is a cross sectional diagram of the low voltage bobbin in FIG. 1. The low voltage bobbin typically comprises a base portion 1 and a bobbin core 2. The bobbin core 2 extends from an outer surface of the base portion 1. A plurality of dividing ribs 21 are distributed around the bobbin core 2. Between adjacent two rounds of the dividing ribs 21 are wrapped a plurality of windings of conductive wires , which is also known as secondary wires 22. After wrapping the secondary wires 22 around the bobbin core 2, the secondary wires 22 are isolated by wrapping an insulating tape 23. A primary wires 24 are then wrapped around the bobbin core 2 over the insulating tape 23.

The prior art low voltage bobbin has several drawbacks. First, short-circuiting between the primary wires 24 and the secondary wires 22 is not allowed, thereby narrowing process window when assembling the low voltage bobbin. This renders the assembling process of the low voltage bobbin labor intensive. Second, the assembling process of the low voltage bobbin is time-consuming, and therefore expensive.

Consequently, there is a need to provide an improved flyback transformer design to solve the above-mentioned problems.

### SUMMARY OF THE INVENTION

It is therefore a primary object of the present invention to provide a new low voltage bobbin of a flyback transformer to solve the above problems.

According to the claimed invention, the low voltage bobbin of a flyback transformer has a bobbin core and a base portion. The low voltage bobbin further comprises an isolating member encompassing the bobbin core in a co-axial manner, a plurality of windings of secondary wires being wrapped around the bobbin core and a plurality of windings of primary wires being wrapped around the isolating member, and a pair of positioning means being provided at a side of the base portion and at associated position of the isolating member such that when assembled together the pair of positioning means engages each other.

It is to be understood that both the forgoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is an exploded diagram of a prior art low voltage bobbin of a flyback transformer (FBT).

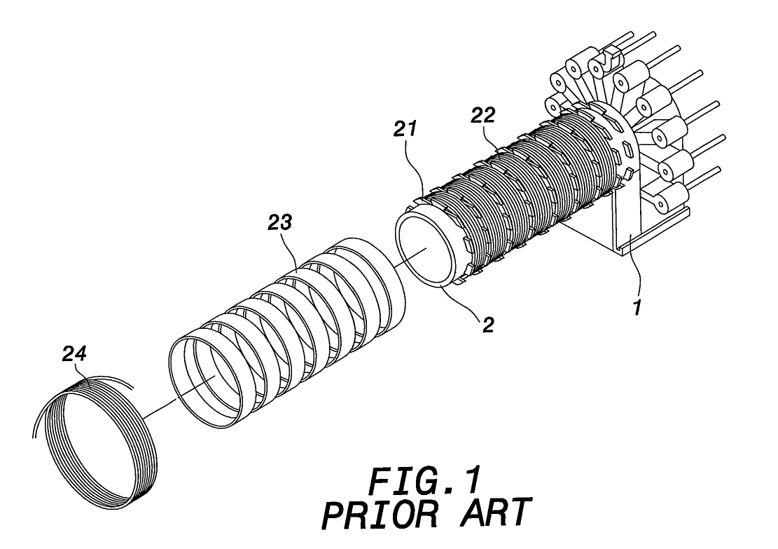

FIG. 2 is a cross sectional diagram of the low voltage bobbin in FIG. 1.

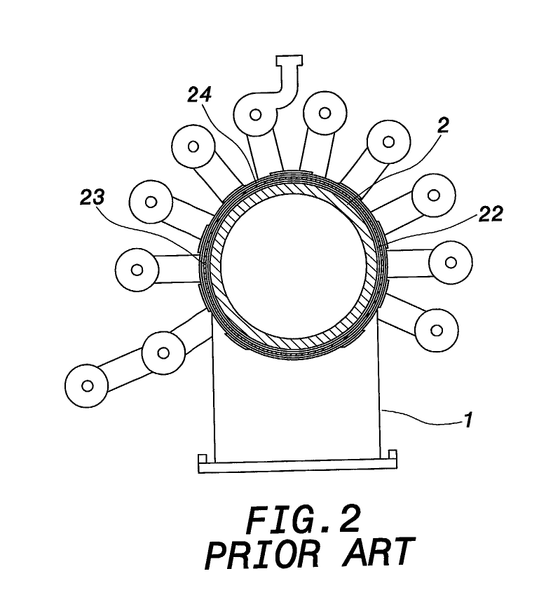

FIG. 3 is an exploded diagram depicting of an improved low voltage bobbin according to one preferred embodiment of this invention.

FIG. 4 is a perspective diagram showing the low voltage bobbin of FIG. 3 after assembling.

FIG. 5 is a cross sectional view of the low voltage bobbin according to the present invention.

FIG. 6 is an exploded diagram of the low voltage bobbin according to the present invention.

### DETAILED DESCRIPTION OF THE PREFERRED EMBODIMENT

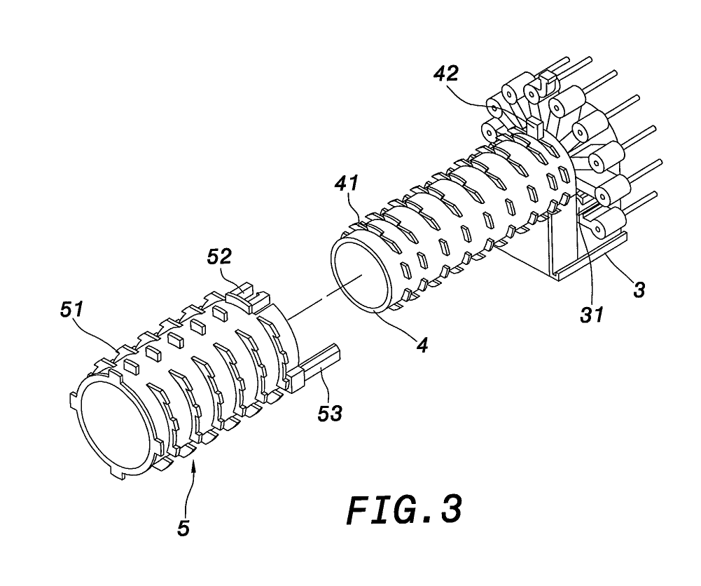

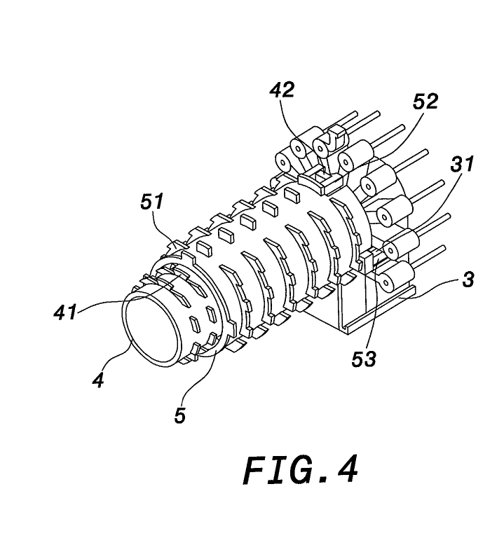

Please refer to FIG. 3 and FIG. 4. FIG. 3 is an exploded diagram depicting of an improved low voltage bobbin according to one preferred embodiment of this invention. FIG. 4 is a perspective diagram showing the low voltage bobbin of FIG. 3 after assembling. As shown in FIG. 3, the present invention provides an improved low voltage bobbin including a base portion 3, a bobbin core 4, and an isolating member 5. The bobbin core 4 is cylindrical and extends from a front surface of the base portion 3. When assembled together, the bobbin core 4 is telescoped into the central opening of the isolating member 5.

A leading slot 31 is provided on a side of the base portion 3. Likewise, a plurality of dividing ribs 41 are distributed on the surface of the bobbin core 4 for dividing a plurality s of windings of conductive wires wrapped around the bobbin core 4. In addition to the dividing ribs 41, a positioning lump 42 upwardly extends from one inner end of the bobbin core 4. The leading slot 31 has an opening that is substantially parallel with the axis of the bobbin core 4. Besides, the positioning lump 42 is not aligned with the leading slot 31. In FIG. 3, the positioning lump 42 is positioned on a top side of the bobbin core 4 relative to the side where the leading slot 31 is located.

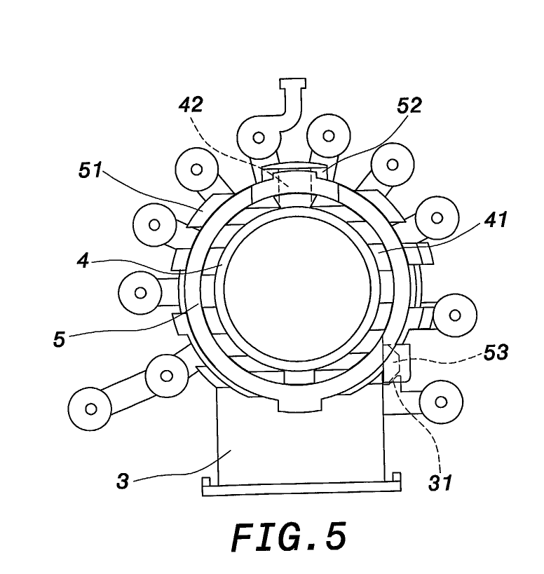

As mentioned, the isolating member 5 is cylindrical. A plurality of dividing ribs 51 are distributed on an outer surface of the isolating member 5 for dividing a plurality of windings of conductive wires wrapped around the isolating member 5. A positioning seat 52 and a leading rod 53 are provided at associated positions corresponding to the positioning lump 42 and the leading slot 31, respectively. When assembled together, the positioning seat 52 snaps the positioning lump 42 and the leading rod 53 slides into the leading slot 31 (as shown in FIG. 4 and FIG. 5).

With reference to FIG. 3 and FIG. 4, when the bobbin core 4 penetrates through the central opening of the cylindrical isolating member 5, the leading rod 53 first reaches the leading slot 31 and is then inserted into the leading slot 31. Thereafter, the positioning seat 52 connect with the positioning lump 42 to complete the combination of the isolating member 5, the base portion 3 and the bobbin core 4.

With reference to FIG. 5 of a cross sectional view of the low voltage bobbin according to the present invention, the bobbin core 4 and the isolating member 5 are combined in a co-axial configuration. A spacing between the bobbin core 4.

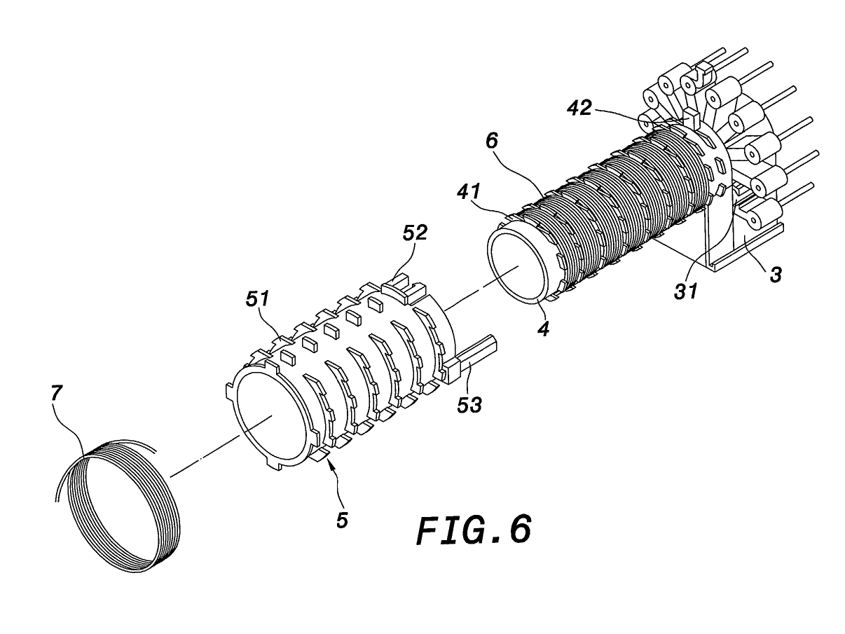

With reference to FIG. 6, a plurality of windings of secondary wires 6 are wrapped around the bobbin core 4, and a plurality of windings of primary wires 7 are wrapped around the isolating member 5. The primary wires and secondary wires be separating by the isolating member. In this way, short-circuiting between the secondary wires 6 and the primary wires 7 can be eliminated, thereby improving the quality of the low voltage bobbin and its electric properties.

Of course, the positioning portion such as the positioning seat 52, the positioning lump 42, the leading rod 53 and leading slot 31 is exemplary and is not supposed to limit this invention. In another embodiment, for example, the positioning lump 42 may be positioned on the isolating member 5, while the positioning seat 52 is positioned on the bobbin core 4. In contrast to the prior art, this invention overcomes the drawbacks of the conventional approach. The isolating member 5 is substituted for the prior art insulating tapes 23. Short-circuiting problems are eliminated since the isolating member 5 can completely isolate the secondary wires and the primary wires. Further, the isolating member permits efficient assembling process.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. A low voltage bobbin of a flyback transformer, comprising:
a bobbin core having a base portion formed with at least a positioning portion; and
a isolating member, said isolating member having at least a positioning portion correspondingly connected to said positioning portion of said base portion of said bobbin core, so that said isolating member encompassing said bobbin core; and
wherein a plurality of windings of primary wires being wrapped around said isolating member and a plurality of windings of secondary wires being wrapped around said bobbin core, thereby said primary wires and secondary wires being separating by said isolating member.

2. The low voltage bobbin of a flyback transformer of claim 1 wherein the isolating member has a cylindrical surface formed with a plurality of dividing ribs thereon.

3. The low voltage bobbin of a flyback transformer of claim 1 wherein the positioning portion of the base portion of bobbin core is in a direction being same as a axial direction of the bobbin core.

4. The low voltage bobbin of a flyback transformer of claim 1 wherein the positioning portion of the isolation member is in a direction being same as a axial direction of side isolation member.

5. The low voltage bobbin of a flyback transformer of claim 1 wherein positioning portion of the base portion of the bobbin core is positioning lump, the positioning portion of the isolation member is positioning seat being correspondingly connected to said positioning lump.
